(19) United States
(12) Patent Application Publication
(10) Pub. No.: US 2026/0311610 A1
(43) Pub. Date: Oct. 8, 2026

(54) SYSTEM AND METHOD FOR PROVIDING OPEN BADGE ISSUANCE SERVICE BASED ON GAMIFICATION

(71) Applicant: SWEMPIRE CO., LTD., Goyang-Si (KR)

(72) Inventor: Myoung Soo CHOI, Goyang-si (KR)

(73) Assignee: SWEMPIRE CO., LTD., Goyang-Si (KR)

(21) Appl. No.: 19/663,194

(22) Filed: Apr. 29, 2026

Related U.S. Application Data
(63) Continuation of application No. PCT/KR2025/013238, filed on Aug. 29, 2025.

(30) Foreign Application Priority Data
Sep. 27, 2024 (KR) 10-2024-0131731

(51) Int. Cl. G09B 5/02

(52) U.S. Cl. CPC G09B 5/02

(57) ABSTRACT

Provided are a device and a method for providing a gamification-based open badge issuance service that reduce a user's trouble of generally visiting an educational institution or the educational institution's homepage to obtain a certificate, an educational qualification, or the like and submitting it directly to consumers (submitting institutions), by issuing and providing a blockchain-based open badge linked to the user's academic achievement such that the user (learner) is capable of proving his/her qualifications acquired through education, learning, examination, or the like provided by the educational institution (learning institution), thereby reducing the time required for issuance and submission as well as incidental costs while security is guaranteed.

### CROSS-REFERENCE TO RELATED APPLICATIONS

The present application is a continuation of International Patent Application No. PCT/KR2025/013238, filed on Aug. 29, 2025, which is based upon and claims the benefit of priority to Korean Patent Application No. 10-2024-0131731 filed on Sep. 27, 2024. The disclosures of the above-listed applications are hereby incorporated by reference herein in their entirety.

### BACKGROUND

Embodiments of the present disclosure described herein relate to a system for providing a gamification-based open badge issuance service, and a method thereof.

With the development of Internet services, most people use, through the Internet, numerous online services such as government institutions, educational institutions, medical institutions, telecommunication companies, financial companies, passenger companies, asset management, credit information, portals, social network services (SNS), games, shopping, ticketing, courier, electronic voting, etc.

Accordingly, users who intend to utilize these services need to sign up as members by entering personal information, including their real name, or to authenticate themselves as registered users by entering a specific ID and a password. However, because it is quite cumbersome to repeat this authentication process at a plurality of sites, a method called simple authentication has been recently developed to easily conduct financial transactions on the Internet by logging in easily.

User authentication has been conventionally performed by using a centralized identify (ID) system. Generally, a public certificate and program Active X for using the public certificate or a separate application (App) for performing authentication has been installed, and then authentication has been made through the program or application.

However, personal information may be leaked or abused in the centralized identity verifying system.

Moreover, when the user's identity is verified by using the program or application, a separate program needs to be installed. Besides, a new authentication application or a new authentication program may not be compatible with existing applications or programs, and thus the user identity may not be smoothly verified.

Nowadays, a decentralized identifiers (DID) technology, which allows users to verify their identities through an issuer, is attracting attention.

In the meantime, an open badge is nowadays emerging as a new digital credentialing method using a blockchain technology. The open badge includes metadata of each individual's learning history, skills, knowledge, honor, experience, and capabilities in a unique image. The reliability of results may be improved by capturing and recognizing a wide range of learning results and verifying them by using a blockchain. In other words, the open badge is a standardized framework capable of sharing a badge, and has qualifications for evaluation, issuance security, and authentication system, thereby securing the reliability of proof.

Accordingly, there is a need to develop a technology that allows users (learners) to prove their capabilities acquired through education, learning, and testing provided by educational institutions (learning institutions) through open badges, and also to expand those capabilities by utilizing those open badges.

### SUMMARY

Embodiments of the present disclosure provide a system and a method for providing a gamification-based open badge issuance service that may reduce a user's trouble of generally visiting an educational institution or the educational institution's homepage to obtain a certificate, an educational qualification, or the like and submitting it directly to consumers (submitting institutions), by issuing and providing a blockchain-based open badge linked to the user's academic achievement such that the user (learner) is capable of proving his/her qualifications acquired through education, learning, examination, or the like provided by the educational institution (learning institution), thereby reducing the time required for issuance and submission as well as incidental costs while security is guaranteed.

Embodiments of the present disclosure provide a system and a method for providing a gamification-based open badge issuance service that may allow a user to easily check the user's fragmented history data by integrating and managing at least one open badge issued to the user, and may allow the user to post the fragmented history data to at least one SNS, thereby quickly and easily utilize the history data for employment or advancement.

Embodiments of the present disclosure provide a system and a method for providing a gamification-based open badge issuance service that may issue various types of open badges in consideration of gamification for unit-specific capabilities and may provide points, gifts, etc. in addition to the open badges, thereby allowing users to voluntarily expand their capabilities by stimulating interest or motivation.

Problems to be solved by the present disclosure are not limited to the problems mentioned above, and other problems not mentioned will be apparent by those skilled in the art from the following description.

According to an embodiment, a gamification-based open badge issuance service providing system includes a first institutional terminal that provides a learning service to a user terminal, and creates or updates history information about a user by receiving learning performance result information from the user terminal, the user terminal that performs learning through a learning service provided by the first institutional terminal, and stores an open badge issued upon requesting a service server to issue the open badge for the learning, and a service server that determines whether to issue the open badge, by determining whether the user has an issuance qualification for the open badge requested to be issued, when an open badge issuance request is received from the user terminal, records the issued open badge on a decentralized identifiers (DID) electronic wallet of the user registered on a blockchain when open badge issuance is completed, and determines whether to provide a reward, based on open badge issuance information and learning activity information of the corresponding user, and then generates issuance information according to the determination result.

According to an embodiment, a gamification-based open badge issuance service providing method performed by a device includes transmitting, by a user terminal, learning performance result information about the learning to a first institutional terminal, when a corresponding user completely performs learning based on a learning service provided by a first institutional terminal, generating or updating, by the first institutional terminal, history information about the corresponding user based on the learning performance result information, determining, by a service server, whether the corresponding user has an issuance qualification for the open badge requested to be issued, through the first institutional terminal when an open badge issuance request for the learning is received from the user terminal, issuing, by the service server, an open badge for the learning based on badge issuance data for the corresponding user when the determination result indicates that the corresponding user has the issuance qualification for the open badge requested to be issued, recording, by the service server, the issued open badge in a DID electronic wallet of the corresponding user registered on a blockchain, determining, by the service server, whether to provide a reward based on open badge issuance information and learning activity information of the corresponding user, and generating, by the service server, issuance information based on the determination result.

Besides, a computer program stored in a computer-readable recording medium for executing a method to implement the present disclosure may be further provided.

In addition, a computer-readable recording medium for recording a computer program for performing the method for implementing the present disclosure may be further provided.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a diagram illustrating a network structure of a gamification-based open badge issuance service providing system, according to an embodiment of the present disclosure;

FIG. 2 is a diagram illustrating a procedure for providing a gamification-based open badge issuance service, according to an embodiment of the present disclosure;

FIG. 3 is a flowchart illustrating an operation of a gamification-based open badge issuance service providing system, according to an embodiment of the present disclosure;

FIG. 4 is a diagram for describing a concept of a gamification-based open badge, according to an embodiment of the present disclosure;

FIG. 5 is a diagram showing a configuration of a service server that provides a gamification-based open badge issuance service, according to an embodiment of the present disclosure;

FIG. 6 is a flowchart illustrating a method for providing a gamification-based open badge issuance service, according to an embodiment of the present disclosure;

FIG. 7 is a flowchart showing a specific operation of issuing an open badge in a method for providing a gamification-based open badge issuance service, according to an embodiment of the present disclosure;

FIG. 8 is a flowchart showing a specific operation of determining whether to provide a reward in a method for providing a gamification-based open badge issuance service, according to an embodiment of the present disclosure;

FIG. 9 is a diagram illustrating an example of a user interface implemented via a user terminal of a user utilizing an open badge issuance service, according to an embodiment of the present disclosure; and

FIG. 10 is a flowchart showing a specific operation of performing DID verification in a method for providing a gamification-based open badge issuance service, according to an embodiment of the present disclosure.

### DETAILED DESCRIPTION

The above and other aspects, features and advantages of the present disclosure will become apparent from the following description of the following embodiments given in conjunction with the accompanying drawings. The present disclosure, however, may be embodied in various different forms, and should not be construed as being limited only to the illustrated embodiments. Rather, these embodiments are provided as examples so that the present disclosure will be thorough and complete, and will fully convey the scope of the present disclosure to those skilled in the art. The present disclosure may be defined by the scope of the claims.

The terms used herein are provided to describe embodiments, not intended to limit the present disclosure. In the specification, the singular forms include plural forms unless particularly mentioned. The terms “comprises” and/or “comprising” used herein do not exclude the presence or addition of one or more other components, in addition to the aforementioned components. The same reference numerals denote the same components throughout the specification. As used herein, the term “and/or” includes each of the associated components and all combinations of one or more of the associated components. It will be understood that, although the terms “first”, “second”, etc., may be used herein to describe various components, these components should not be limited by these terms. These terms are only used to distinguish one component from another component. Thus, a first component that is discussed below could be termed a second component without departing from the technical idea of the present disclosure.

Unless otherwise defined, all terms (including technical and scientific terms) used herein have the same meaning as commonly understood by those skilled in the art to which the present disclosure pertains. Moreover, terms, such as those defined in commonly used dictionaries, should not be interpreted in an idealized or overly formal sense unless expressly so defined herein.

The same reference numerals denote the same elements throughout the present disclosure. The present disclosure does not describe all elements of embodiments. Well-known content in a technical field, to which the present disclosure belongs, or redundant content in which embodiments are the same as one another will be omitted. The term “unit” or “module” used herein may refer to software or hardware such as field programmable gate array (FPGA) or application specific integrated circuit (ASIC), and the “unit” or “module” may perform some functions. However, the “unit” or “module” may be not limited to software or hardware. The “unit” or “module” may be configured to exist in an addressable storage medium or may be configured to operate one or more processors. Therefore, as an example, “units” or “module” may include various elements such as software elements, object-oriented software elements, class elements, and task elements, processes, functions, attributes, procedures, subroutines, program code segments, drivers, firmware, microcodes, circuits, data, databases, data structures, tables, arrays, and variables. Functions provided in “units” or “modules” and elements may be combined into a smaller number of “units” or “modules” and elements or may be divided into additional “units” or “modules” and elements.

Throughout this specification, when it is supposed that a portion is “connected” to another portion, this includes not only a direct connection, but also an indirect connection. The indirect connection includes being connected through a wireless communication network.

Furthermore, when a portion “comprises” a component, it will be understood that it may further include another component, without excluding other components unless specifically stated otherwise.

Throughout this specification, when it is supposed that a member is located on another member “on”, this includes not only the case where one member is in contact with another member but also the case where another member is present between two other members.

Terms such as ‘first’, ‘second’, and the like are used to distinguish one component from another component, and thus the component is not limited by the terms described above.

Unless there are obvious exceptions in the context, a singular form includes a plural form.

In each step, an identification code is used for convenience of description. The identification code does not describe the order of each step. Unless the context clearly states a specific order, each step may be performed differently from the specified order.

Hereinafter, definitions of terms used in the description are as follows.

In the present disclosure, the description is limited to a service server 300. However, the present disclosure may further include a server, a computer, and/or a portable terminal, or may be in a form of any one thereof.

Here, the server may be a server that processes information by communicating with an external device and may include an application server, a computing server, a database server, a file server, a game server, a mail server, a proxy server, and a web server.

For example, the computer may include a notebook computer, a desktop computer, a laptop computer, a tablet PC, a slate PC, and the like, which are equipped with a web browser.

For example, the portable terminal may be a wireless communication device that guarantees portability and mobility, and may include all kinds of handheld-based wireless communication devices such as a smartphone, a personal communication system (PCS), a global system for mobile communication (GSM), a personal digital cellular (PDC), a personal handyphone system (PHS), a personal digital assistant (PDA), International Mobile Telecommunication (IMT)-2000, a code division multiple access (CDMA)-2000, W-Code Division Multiple Access (W-CDMA), and Wireless Broadband Internet (WiBro) terminal, and a wearable device such as a timepiece, a ring, a bracelet, an anklet, a necklace, glasses, a contact lens, or a head-mounted device (HMD).

Hereinafter, operating principles and embodiments of the present disclosure will be described with reference to the accompanying drawings.

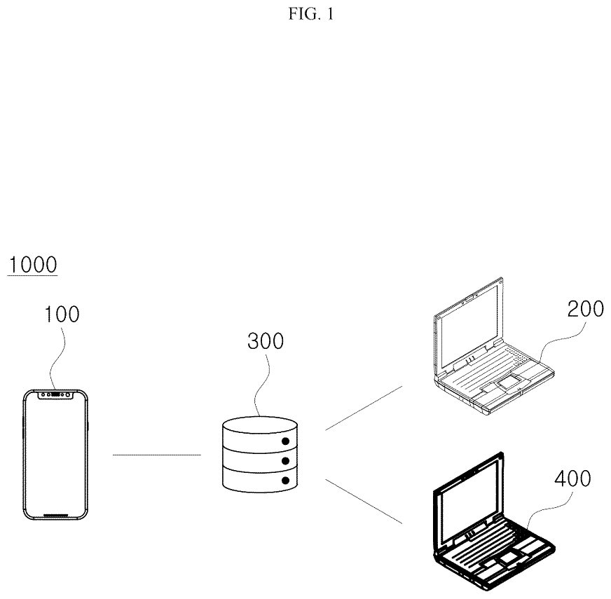

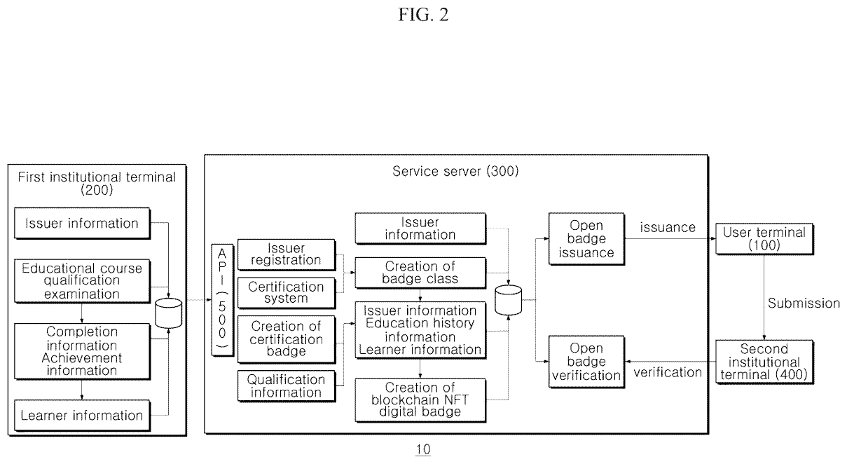

FIG. 1 is a diagram illustrating a network structure of a gamification-based open badge issuance service providing system, according to an embodiment of the present disclosure. FIG. 2 is a diagram illustrating a procedure for providing a gamification-based open badge issuance service, according to an embodiment of the present disclosure.

Referring to FIG. 1, a gamification-based open badge issuance service providing system (hereinafter referred to as a ‘service providing system’) 1000 according to an embodiment of the present disclosure may include a user terminal 100, a first institutional terminal 200, a gamification-based open badge issuance service providing device (hereinafter referred to as a ‘service server’) 300, and a second institutional terminal 400. Here, the one first institutional terminal 200 and the one second institutional terminal 400 are described, but this is only for convenience of description. The number or type thereof is not limited thereto. In the meantime, for convenience of description, a learning institution is described by way of example. However, the present disclosure may be applied to, but is not limited to, any other organization that provides users with courses for obtaining qualifications for learning, education, work, or the like.

The user terminal 100 is a terminal of a user (recipient) who obtains qualifications related to learning, education, work, or the like, by performing the learning, the education, the work, or the like, which is provided by at least one first institution based on the first institutional terminals 200. To receive an open badge issuance service, the user terminal 100 registers an issuer's distributed ID information on a blockchain (trusted ID storage) through the service server 300 (i.e., DID user registration). In this case, when DID user registration is performed, a user (i.e., a user's identity) may be verified through one of a plurality of authentication methods while the initial distributed ID is issued. Here, the plurality of authentication methods may correspond to integrated authentication and may include at least one of biometric authentication, PIN numbers, and patterns.

In the meantime, when a user holding the user terminal 100 obtains qualifications and then requests the service server 300 to issue an open badge including the assertion of performance information as a result of the performance of learning, education, work, or the like provided by the first institutional terminal 200, the open badge is issued from the service server 300 in response to the request. Meanwhile, the issued open badge may be presented or displayed to the second institutional terminal 400, which is a demanding terminal, at the request of the user terminal 100.

In the meantime, the first institutional terminal 200 may be a device or server equipped (installed) in a learning institution, and may provide a separate web page or platform (application) to provide the learning service. In other words, the first institutional terminal 200 may build and provide a separate web page or platform (application), the first institutional terminal 200 provides the requested learning service to the at least one user terminal 100 registered for the learning service based on the web page or platform.

The first institutional terminal 200 stores and manages not only the user's user information, but also history information about learning. Here, the user information may include at least one of a user's name, age, gender, address, contact information, and academic background. The history information may include at least one of login information including a login history, admission information (year of admission, department, student number, etc.), major information, lecture information (semester information, lecture codes, classification codes, course registration information, curriculum, lecture content, completion statuses, credits earned, etc.), learning course information (student numbers, course codes, completion statuses, etc.), inquiry information (question name/question content, response name/response content, etc.), assignment information, grade information, and evaluation information (evaluation results of proficiency, ability, talent, etc.) about the user.

Moreover, the first institutional terminal 200 provides the corresponding learning service at the request of the user terminal 100. When the user completes the learning course for a specific learning through the user terminal 100, the first institutional terminal 200 receives the learning performance result and then grants the user the qualification corresponding to the learning course. In this case, on the basis of the learning performance result, the first institutional terminal 200 may newly create history information about the user or may update the existing history information.

Accordingly, when the user terminal 100, the service server 300, and the demanding institution 400 are directly or indirectly requested to identify the eligibility of the user or to identify the eligibility for receiving an open badge, the first institutional terminal 200 may identify and answer the eligibility based on the user information and the history information. In this case, the first institutional terminal 200 may determine whether the corresponding user satisfies requirements for obtaining an open badge, based on the pre-stored criteria. When the requirements are satisfied, the first institutional terminal 200 may provide the service server 300 with badge issuance data obtained by extracting some history information from the history information. However, this is only an example, and the history information about the user may be provided as it is to the service server 300 without the need to extract the badge issuance data from the history information.

Here, the at least one or more first institutional terminals 200 may be provided. While each of the first institutional terminals 200 is linked (connected) to the service server 300 through an application programming interface (API), the system, format, or the like for qualifications, certificates, or the like that is capable of being issued by each first institution (a learning institution, an educational institution, or the like) may be stored together.

In the meantime, the service server 300 may perform an operation of managing badge issuance data, registering and managing a badge issuance institution, providing a badge standard guide, building a badge operating framework, verifying a badge issuance institution and a badge issuance history, and providing badge issuance data information. Here, the badge issuance data may be data for badge issuance, and may be data extracted from the history information stored and managed by the first institutional terminal 200. However, this is only one example, and the service server 300 may receive the user's history information as it is, and is not limited thereto.

The service server 300 issues an open badge based on the badge issuance data or the history information, and then registers the badge issuance data on a blockchain so as to be registered. In this case, the badge issuance data or the history information includes a public key used to sign the assertion of the first institutional terminal 200. The public key may be used later for DID verification. Additionally, the service server 300 may revoke an open badge. In this case, the required method of revoking an open badge differs based on whether the assertion is a hosted assertion or a signed assertion.

In the meantime, when issuing an open badge, the service server 300 issues the open badge by identifying (measuring) at least one of the corresponding user's learning chunks, proficiency, competency, and talent based on the badge issuance data or the history information.

In other words, the open badge may include metadata such as the user's performance and competency within the badge image, and may be verified anytime, anywhere. Here, the metadata may be recorded on a conventional digital badge and may be based on the minimum metadata. For example, necessary metadata may include at least one of first institution data (an issuer name, an issuer address, an issuer description, whether the issuer is accredited, or the like), a badge class (the name of a course, whether the course is accredited, the feature/level of the accredited course, a course category, nature/level of the course, completion/qualification acquisition criteria, a qualification quality assurance type, or the like), acquisition data (completion/acquisition qualification, badge issuance date, badge expiration date, assessment type, a learning activity participation type, or the like), an earner (an earner name, earner information, or the like), and verification information (verification URL, or the like). Optional metadata may include at least one of additional information about an issuer, course completion criteria/cycles, evidence URL, withdrawal/reasons for withdrawal, a possibility of integration with other badges, other service purpose information, prerequisite learning requirements for course registration, assessment courses, scores earned, connectivity with other courses, characteristics of a qualification created by integration/accumulation with other courses, and a location on a learning portfolio/career path.

When there is a request from an earner or demander due to the closure of the issuer or the loss or damage of data, the metadata may be used to verify the data.

Besides, the service server 300 stores and searches for smart contract-based blockchain data for an open badge. In this case, data search performance may be improved by generating actual data blocks in one file format by using a data block allocation table linked to a data registration transaction, and caching meta information of data and the data block allocation table. Furthermore, the data search performance may be improved by creating actual data blocks in one file format by using a data block allocation table linked to a data registration transaction, and caching data meta information and the data block allocation table. To this end, data may be encrypted based on unique information generated by the smart contract, and the encrypted data may be applied such that a decryption key is automatically obtained depending on access control permissions.

To this end, the service server 300 may build and provide a separate web page or platform (application). Each device (a user terminal, an issuing institutional terminal, a demand institutional terminal, or the like) registered for an open badge issuance service may receive the open badge issuance service based on the web page or platform (application).

A dashboard for each user may be implemented on this web page or platform. At least one open badge (i.e., DID status) issued to each user may be configured on the dashboard in the form of a portfolio. In this way, the user may identify various types of information about at least one open badge issued to him/her through his/her DID status by executing a web page or platform through the user terminal 100.

The service server 300 may perform DID registration, open badge issuance, DID verification, or the like on a user based on an API 500 previously linked. In addition, although not illustrated in FIG. 1, the service server 300 may be connected (linked, etc.) to at least one learning server and at least one search server to collect learning activity information and search result information from each server and to utilize the information for the open badge issuance service.

In the meantime, the service server 300 may determine whether to provide a reward, based on the corresponding user's open badge issuance information and learning activity information, and then may generate issuance information based on the determination result. That is, by motivating users to engage in learning activities in consideration of gamification, stimulating the desire to achieve rewards may encourage active learning participation in the case of users with low learning activity, and providing rewards may spark interest and encourage even more active learning participation in the case of users with high learning activity.

Meanwhile, the service server 300 generates and provides learning curation information for open badges issued based on pre-stored curriculum information. In this case, the service server 300 may process the learning curation information at the request of the user terminal 100, or may process it immediately after the open badge is issued. Accordingly, the service server 300 may independently provide the learning curation information, or it may be included in the open badge issuance information. The method or form of provision is not limited thereto.

In the meantime, the second institutional terminal 400 may be a device (terminal) installed in a consumer. When the open badge is submitted or displayed from the user terminal 100, the second institutional terminal 400 may request the service server 300 to verify an assertion, which is digitally signed in the open badge, based on a public key such that DID verification is performed.

Accordingly, when the verification from the service server 300 is completed, it may be determined whether to accredit the user's qualification for the open badge, based on the verification result.

In the meantime, the user terminal 100, the first institutional terminal 200, and the second institutional terminal 400 may be a computer, an ultra-mobile PC (UMPC), a workstation, a net-book, personal digital assistants (PDA), a portable computer, a web tablet, a wireless phone, a mobile phone, a smart phone, a pad, a smart watch, a wearable terminal, an e-book, a portable multimedia player (PMP), a portable game console, a navigation device, a black box or digital camera, other mobile communication terminals, or the like, on which a user/a first institution (an educational institution, a learning institution, or the like)/a consumer (a demander, a submission location, or the like) is capable of installing and executing a plurality of desired application programs (i.e., applications). In this case, the user terminal 100, the first institutional terminal 200, and the second institutional terminal 400 may be provided in various forms and is not limited thereto.

As described above, a service providing system 1000 according to an embodiment of the present disclosure may be implemented through data transmission and reception between the user terminal 100, the first institutional terminal 200, the service server 300, and the second institutional terminal 400.

In the meantime, although not illustrated in FIGS. 1 and 2, the service providing system 1000 may be connected to other external servers. For example, the service providing system 1000 may further include at least one learning server, at least one search server, and the like. For example, the learning server may be a server for providing a learning service on an online or offline basis, and the search server may be a server for providing an information search service.

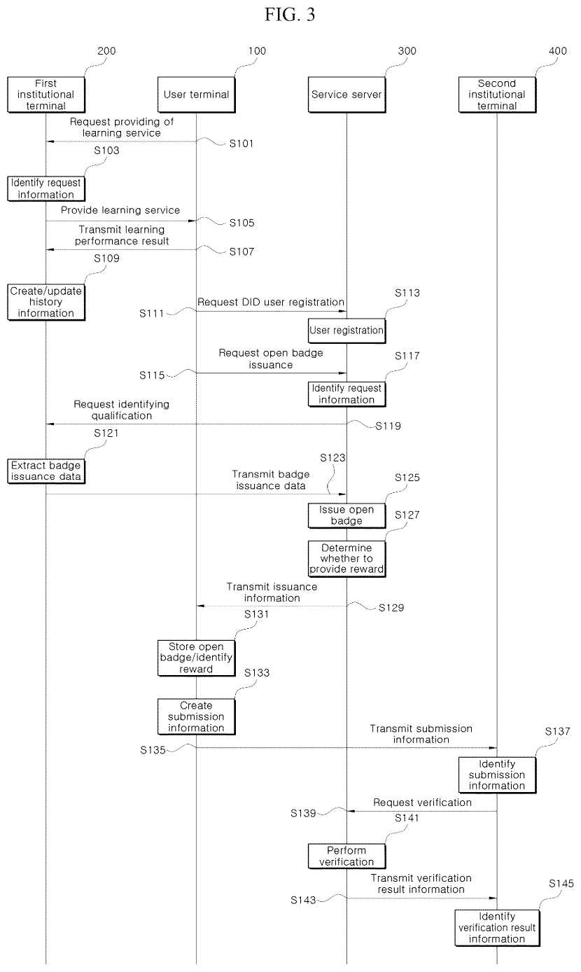

FIG. 3 is a flowchart illustrating an operation of a gamification-based open badge issuance service providing system, according to an embodiment of the present disclosure.

Referring to FIG. 3, the user terminal 100 transmits a learning service providing request to the first institutional terminal 200 to receive a learning service by a first institution (S101). In this case, the learning service providing request may be a request for subscribing to the learning service when a user is a new user. When the user is an existing subscribed user, the learning service providing request may be a request for providing specific learning among at least one learning service.

Next, the first institutional terminal 200 identifies request information in step S101 (S103). After the first institutional terminal 200 determines whether to provide the learning service by determining whether the user has access permissions, the first institutional terminal 200 provides the requested learning service only to the accessible user (S105).

Next, the user terminal 100 performs the learning service provided by the first institutional terminal 200. When the corresponding learning service is completely performed, the user terminal 100 transmits the learning performance result to the first institutional terminal 200 (S107).

Next, on the basis of the learning performance result received in step S107, the first institutional terminal 200 newly creates history information for the corresponding user or updates the previously created history information (S109).

Afterward, the user terminal 100 transmits a DID user registration request to the service server 300 to receive an open badge issuance service (S111), and performs DID user registration by registering the user's distributed ID information on the trusted ID storage (i.e., a blockchain) of the service server 300 (S113). In this case, the DID electronic wallet for the corresponding user may be created.

Next, when the user terminal 100 intends to receive an open badge, the user terminal 100 transmits the open badge issuance request to the service server 300 (S115). In this case, although not shown in FIG. 3, when the user terminal 100 requests open badge issuance, the user terminal 100 may receive at least one open badge, which is capable of being issued by the service server 300, in a list form (hereinafter referred to as an “issuable open badge list’) from the service server 300. In other words, a user may transmit an issuance request for any open badge by selecting the open badge from the list. To this end, the service server 300 may perform an operation of registering the at least one first institutional terminals 200 in advance, and may identify at least one open badge, which is capable of being issued to each user, through history information of each user from the registered the at least one first institutional terminals 200. In the meantime, in another embodiment, the service server 300 may support the acquisition of additional open badge issuance qualifications by recommending issuing an issuable open badge in addition to the open badge requested by the user, or recommending other learning related to the previously issued open badge.

Next, the service server 300 identifies the request information in step S115 (S117), transmits a request for a qualification check to the first institutional terminal 200, and requests the first institutional terminal 200 to identify the user's qualification for the open badge for which the issuance is requested (S119).

Next, the first institutional terminal 200 identifies the user's history information depending on the request in step S119, extracts data (i.e., badge issuance data) for issuing a badge from the history information (S121), and transmits the badge issuance data to the service server 300 (S123).

Next, the service server 300 issues the open badge, of which the issuance is requested, based on the badge issuance data obtained in step S123 (S125), determines whether to provide rewards to the corresponding user (S127), and transmits the issuance information generated based on that determined results to the user terminal 100 (S129).

Next, the user terminal 100 may store the open badge issued based on the issuance information received in step S129 and may identify the reward. In this case, the reward may only be identified even when a reward to be provided in step S127 is present. Meanwhile, this issuance information may further include a first notification capable of being included when no reward is to be provided, or a second notification capable of being included when a reward is to be provided. Moreover, the user may be allowed to post the stored open badge to at least one SNS installed on the user terminal 100 as needed.

Afterward, the user terminal 100 generates submission information including the open badge stored in step S131 (S133) to submit the open badge corresponding to the corresponding qualification to a second institution, by which the user desires to be credentialed, and transmits the submission information to the second institutional terminal 400 (S135).

Next, the second institutional terminal 400 identifies the submission information (S137), and requests the service server 300 to verify the open badge included in the submission information (S139).

Accordingly, the service server 300 verifies the open badge depending on the request in step S139 (S141), and generates verification result information including the verification result and transmits the verification result information to the second institutional terminal 400 (S143).

Next, the second institutional terminal 400 determines whether to credential the user's qualification by identifying the verification result information received in step S143 (S145).

Meanwhile, in FIG. 3, it is described that issuance information is generated and provided differently depending on whether a reward is provided, this is only one example. The issuance information may be generated by including only the open badge issued in step S125, and a series of operations related to reward provision may be performed independently.

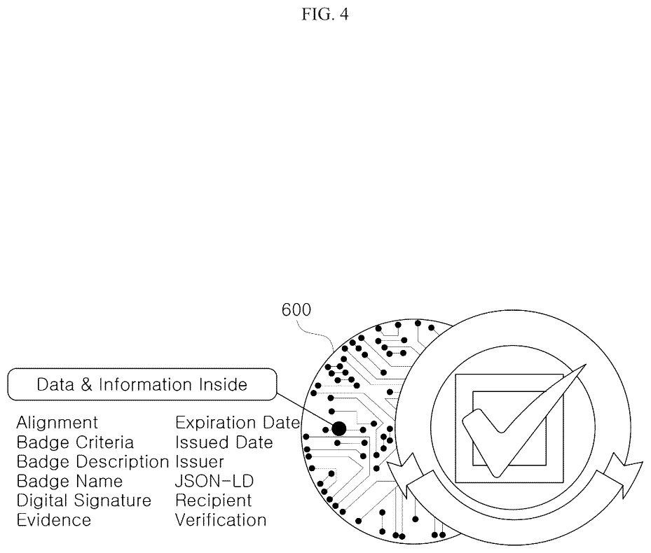

FIG. 4 is a diagram for describing a concept of a gamification-based open badge, according to an embodiment of the present disclosure.

First of all, an open badge 600 may be issued, obtained, and managed through an open badge platform that supports an open badge standard. As shown in FIG. 4, the open badge 600 includes information about content of guaranteed skills, issuer information, user information thus obtained and displayed, expiration date, a method for verification, or the like. The open badge 600 may also be approached from an ecological perspective. Major stakeholders may be classified into three types: an issuance institution that issues the open badge 600, a user that obtains the badge, and a company that develops an open badge platform.

First of all, the open badge 600 determines whether to be issued, as qualifications are assigned by a learning institution. The learning institution may divide learning into small chunks to provide the small chunks to a user, may credential the learning based on proficiency, may grant an issuance qualification for the open badge as a means of recognition for microcredentials, and may measure and maintain the user's abilities (talent, qualifications).

Moreover, the user who receives the open badge 600 may submit (present) the open badge as evidence of the skills or academic achievements, which he/she has learned, to go on to an advanced school or to find a job, may make a request for issuance information to an issuer when the open badge is issued to the user, may collect the open badge 600 in a portfolio or backpack to provide a notification of his/her story, and may share his/her open badge 600 with social media or the community. That is, the open badge 600 may be posted on at least one SNS at the request of the user terminal 100.

Moreover, the company that finds business opportunities may design a system capable of recognizing and verifying small chunks of learning provided by learning institutions, may develop a tool for tracking the user's engagement levels, extending resources, creating the open badge 600, and displaying/hosting the open badge, may apply an open badge standard, and may obtain conformity certification.

Meanwhile, the open badge 600 may include an issuer, a badge class, and an assertion. Here, the assertion may include performance information about the history performed by the corresponding user.

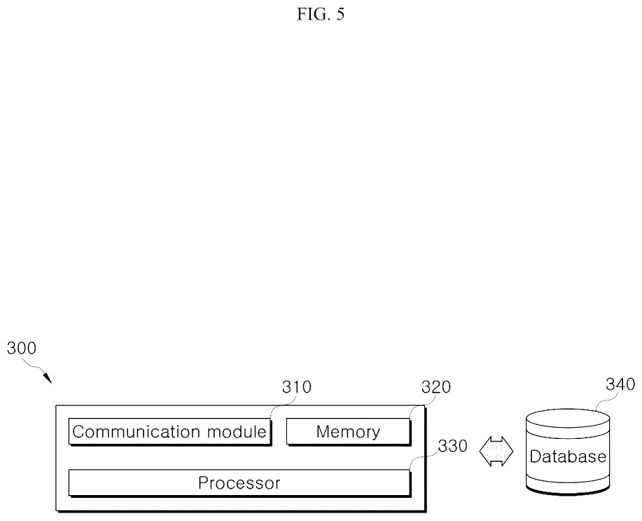

FIG. 5 is a diagram showing a configuration of a service server that provides a gamification-based open badge issuance service, according to an embodiment of the present disclosure.

Referring to FIG. 5, according to an embodiment of the present disclosure, the service server 300 that provides a gamification-based open badge issuance service may include a communication module 310, a memory 320, and a processor 330.

The communication module 310 may perform wired or wireless communication with at least one external device (a server, etc.), external storage (e.g., a database 340), an external server, and at least one cloud server as well as the user terminal 100, the first institutional terminal 200, and the second institutional terminal 400. In particular, when the wireless communication is performed, wireless signals are exchanged over a communication network based on wireless Internet technologies.

In the meantime, the external server or the cloud server may be configured to perform at least part of the role of the processor 330. In other words, data processing or data operations may be performed by an external server or a cloud server, and the present disclosure does not place any special restrictions on this method.

The communication module 310 may include one or more components that enable communication with an external device. The communication module 310 may include, for example, at least one of a wired communication module, a wireless communication module, and a short-range communication module, and may transmit and receive signals based on the at least one communication module.

Here, in addition to various wired communication modules such as a Local Area Network (LAN) module, a Wide Area Network (WAN) module, or a Value Added Network (VAN) module, the wired communication module may include a variety of cable communication modules such as Universal Serial Bus (USB), High Definition Multimedia Interface (HDMI), Digital Visual Interface (DVI), recommended standard (RS-232), power line communication, or plain old telephone service (POTS).

In addition to a Wi-Fi module and a Wireless broadband (WiBro) module, the wireless communication module may include a wireless communication module that supports various wireless communication methods such as global System for Mobile Communication (GSM), Code Division Multiple Access (CDMA), Wideband Code Division Multiple Access (WCDMA), universal mobile telecommunications system (UMTS), Time Division Multiple Access (TDMA), Wireless LAN (WLAN), Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), 4G, 5G, 6G, or the like.

The short-range communication module may be used for short range communication, and may support short-range communication by using at least one of Bluetooth™, radio frequency identification (RFID), infrared data association (IrDA), ultra wideband (UWB), ZigBee, near field communication (NFC), Wireless-Fidelity (Wi-Fi), Wi-Fi Direct, and wireless universal serial bus (Wireless USB) technologies.

In particular, the communication module 310 may receive a request for issuance, authentication, or the like of an open badge from each of the user terminal 100, the first institutional terminal 200, and the second institutional terminal 400 based on wired or wireless communication and may transmit the result for the request. Furthermore, various types of information for issuing and authenticating the open badge may be exchanged with the user terminal 100, the first institutional terminal 200, and/or the second institutional terminal 400 through the communication module 310. In addition, the communication module 310 exchanges various types of information with at least one external device.

The memory 320 stores data and/or various types of information for supporting various functions of the service server 300. The memory 320 may store a plurality of application programs (or applications) running in the service server 300, data for an operation of the service server 300, and instructions. At least part of the application programs may be downloaded from an external server through wireless communication. In the meantime, the application program may be stored in at least one memory provided in the memory 320, may be installed in the service server 300, and may be driven so as to perform an operation (or function) executed by at least one processor provided in the processor 330.

In the meantime, the at least one memory may include a storage medium of at least one type of a flash memory type, a hard disk type, a multimedia card micro type, a card type memory (e.g., SD memory, XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, etc. Besides, the memory may store information temporarily, permanently, or semi-permanently, and may be provided in an embedded type or a removable type.

The memory 320 may establish and store a database 340 for providing an open badge issuance service. The database 340 may store various pieces of information about at least one respective user (a recipient, an educational institution, a receiving institution, or the like) subscribed to the open badge issuance service. Moreover, the memory 320 may store at least one process for providing the open badge issuance service.

The processor 330 may include at least one processor for providing the open badge issuance service. The processor 330 may allow all components within the service server 300 to process signals, data, information, or the like, which is input or output, or may perform various processes by executing commands, algorithms, and application programs stored in at least one memory.

That is, all operations performed by the service server 300 described above based on FIGS. 1 and 2 may be performed under control of the processor 330.

In detail, when an open badge issuance request is received from the user terminal 100, the processor 330 determines whether to issue the open badge by determining whether a user possesses the eligibility to receive the requested open badge. Subsequently, when the open badge issuance is completed based on the determination, the processor 330 records and manages the issued open badge in the user's DID electronic wallet registered on a blockchain.

In the meantime, the processor 330 may determine whether to provide a reward, based on the corresponding user's open badge issuance information and learning activity information, and then may generate issuance information based on the determination result. To this end, the processor 330 may collect learning activity information and search result information from each of at least one pre-connected learning server and at least one search server, and may utilize the collected learning activity information and/or search result information to provide rewards. Here, the learning activity information may include at least one of a learning level, a learning history, a test history, learning results, test results, a learning time, a learning rate, and a progress rate during a preset period.

As an example, the processor 330 analyzes the corresponding user's open badge issuance information and the learning activity information, and determines whether at least one preset reward provision condition is satisfied, based on the analysis results.

When the determination result indicates that at least one reward provision condition is not satisfied, the processor 330 generates issuance information so as to include a first notification for providing learning motivation. At this time, the first notification may be used to determine a user's learning level or learning interests based on learning activity information and to receive search result information through at least one search server based on this determined result. Accordingly, the first notification may be provided to include the search result information. However, the first notification may be a notification sent when a user is not eligible for rewards, and may include learning content or learning institutions within the user's scope of interest. Furthermore, the processor 330 may modify at least one reward provision condition such that the user is capable of easily achieving the goal. In other words, this may lower the barrier to entry.

When the determination result indicates that at least one reward provision condition is satisfied, the processor 330 generates issuance information so as to include a second notification for providing reward provision. At this time, the second notification may be used to determine a user's learning level based on learning activity information and to receive search result information through at least one search server based on this determined result. Accordingly, the second notification may be provided to include the search result information. However, the second notification refers to a notification sent when a user is eligible for a reward. Therefore, by determining a learning map based on curriculum information corresponding to the user, rather than the user's interests, the second notification may include learning content related to the user's learning level, or learning institutions specialized in that learning. Furthermore, the processor 330 may change at least one reward provision condition such that the corresponding user is capable of receiving a greater reward.

Here, each of the first and second notifications may be based on at least one of text, numbers, emoticons, images, audio, video, and graphs.

Furthermore, the reward may include at least one of an additional open badge, points, coupons, gifts, and content. Here, the additional open badge may be a badge for a competency having a unit smaller than the open badge and may be composed by structuring at least one grade. For example, at least one grade may include at least one of a mega badge, a macro badge, a micro badge, and a nano badge.

Accordingly, the processor 330 may determine one grade among at least one grade based on the achievement degree of at least one reward provision condition and may issue a badge of the determined grade as a reward. Users may identify not only the open badge issued for learning, but also an additional open badge issued as a reward, on a platform or webpage established for the open badge issuance service. In this case, the open badge and the additional open badge may be managed either integrated or separately, but this is not limited thereto.

Besides, the preset reward provision condition may be automatically set or changed by analyzing the corresponding user's learning activity information based on pre-stored curriculum information, or may be manually set or changed by the corresponding user.

In the meantime, when a DID user registration request is received from the user terminal 100, the processor 330 performs DID registration on a blockchain by verifying user identity through integrated authentication (biometric authentication, PIN number, and patterns) while issuing a first distributed ID.

In the meantime, when an open badge issuance request for the corresponding user is received from the user terminal 100, after the processor 330 performs user authentication by accessing a distributed ID based on one of a plurality of authentication methods, the processor 330 provides an issuable open badge list including at least one issuable open badge for the corresponding user. When one of the open badges is selected from the issuable open badge list, the processor 330 issues an open badge by identifying and combining the history data and format based on a DID electronic wallet of the corresponding user registered in the blockchain.

Moreover, when a DID verification request for a previously issued open badge is received from the user terminal 100 or the second institutional terminal 400, the processor 330 performs user authentication by accessing the distributed ID based on one of the plurality of authentication methods and performs DID verification on the previously issued open badge based on the DID electronic wallet of the corresponding user registered in the blockchain.

In this case, when the processor 330 performs DID verification, the processor 330 may verify badge issuance data by using a hash value of an open badge (an open badge for which DID verification is requested) thus previously issued, and a hash value of the open badge previously registered in the blockchain. Here, the hash value of the previously issued open badge may be obtained based on a public key used to sign the digitally signed assertion on the open badge.

The processor 330 may perform DID verification based on the linked API.

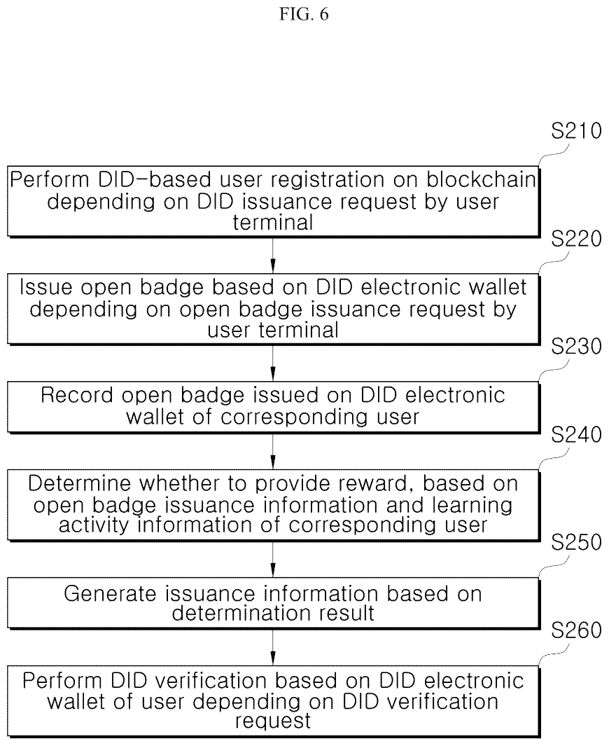

FIG. 6 is a flowchart illustrating a method for providing a gamification-based open badge issuance service, according to an embodiment of the present disclosure.

Referring to FIG. 6, a user performs DID user registration on a blockchain to the service server 300 by transmitting a DID user registration request by using the user terminal 100 to receive an open badge issuance service (S210).

Next, when the user terminal 100 requests the issuance of an open badge by selecting an issuance item, the service server 300 issues the open badge based on a DID electronic wallet of the corresponding user through the linked API (S220).

Next, the service server 300 records the previously issued open badge in a corresponding user's DID electronic wallet registered on the blockchain (S230) and determines whether to provide a reward, based on the corresponding user's open badge issuance information and learning activity information (S240). In this case, the open badge issuance information may be collected and identified through the database 340, and the learning activity information may be collected and identified from at least one learning server, as described above.

Next, the service server 300 generates issuance information based on the determination result in step S240 (S250). The generated issuance information may be provided to the user terminal 100.

Additionally, when a DID verification request for the open badge thus previously issued is received from the user terminal 100 or the second institutional terminal 400, the service server 300 performs DID verification on the open badge based on the DID electronic wallet of the corresponding user through the previously linked API (S260).

Here, step S260 may not be a necessary operation and may be optionally performed as needed.

In the meantime, although not shown in FIG. 6, the service server 300 may register at least one issuer in or before step S210. In this case, the system, format, or the like for qualifications, certificates, or the like credentialed by each first institution may be stored together.

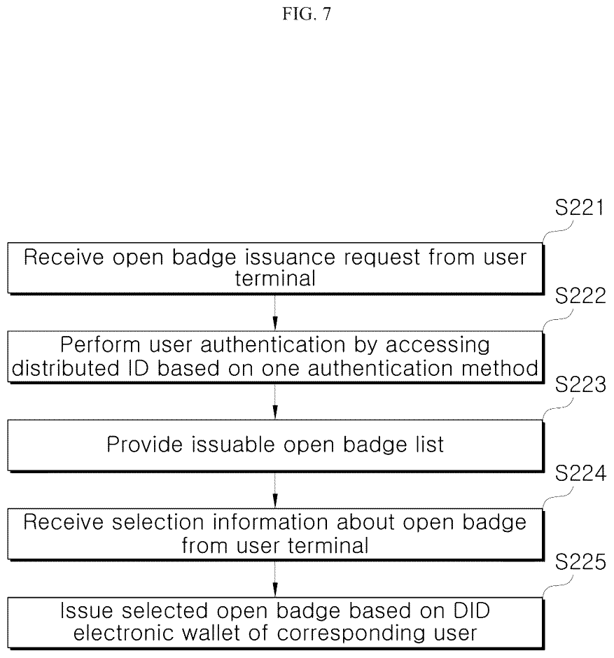

FIG. 7 is a flowchart showing a specific operation of issuing an open badge in a method for providing a gamification-based open badge issuance service, according to an embodiment of the present disclosure.

Referring to FIG. 7, when an open badge issuance request for the corresponding user is received from the user terminal 100 (S221), the service server 300 performs user authentication by accessing a distributed ID based on one of a plurality of authentication methods (S222).

Next, the service server 300 provides an issuable open badge list including at least one issuable open badge for the corresponding user (S223). When selection information generated as a user selects one open badge from the issuable open badge list is received through the user terminal 100 (S224), the service server 300 issues the selected open badge by identifying and combining the history data and format based on a DID electronic wallet of the corresponding user, which is registered in a blockchain (S225).

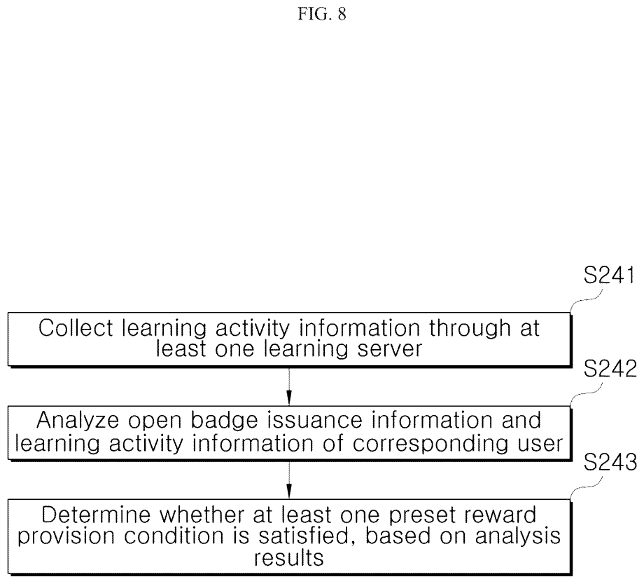

FIG. 8 is a flowchart showing a specific operation of determining whether to provide a reward in a method for providing a gamification-based open badge issuance service, according to an embodiment of the present disclosure.

Referring to FIG. 8, the service server 300 collects learning activity information through at least one learning server (S241).

Next, the service server 300 analyzes the corresponding user's open badge issuance information and the learning activity information (S242), and determines whether at least one preset reward provision condition is satisfied, based on the analysis results (S243).

For example, the at least one reward provision condition may be set based on at least one variable of a learning level, test results (scores), learning outcomes (completion status), a learning time, a learning rate, a progress rate, and the number of open badges acquired by performing learning during a preset period. Whether to provide a reward may be determined by comparing each variable with a preset threshold.

Based on the determination result, issuance information including a first notification may be generated in step S250 in FIG. 6, or issuance information including a second notification may be generated.

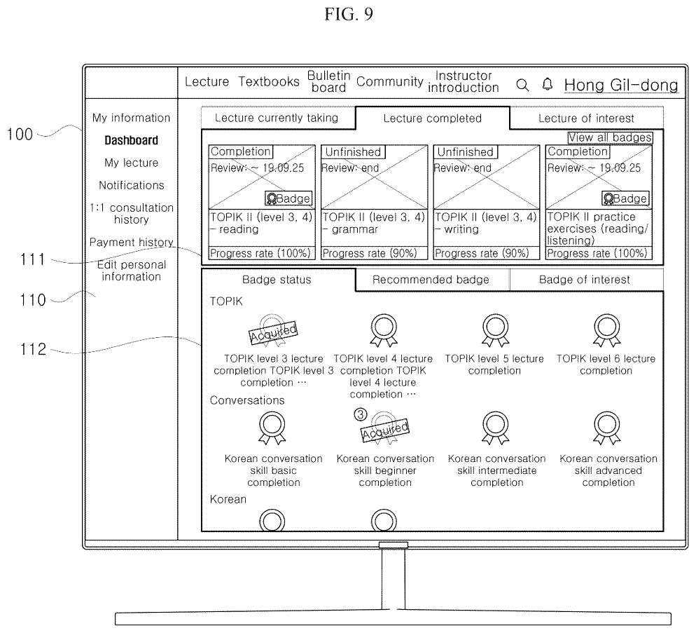

FIG. 9 is a diagram illustrating an example of a user interface implemented via a user terminal of a user utilizing an open badge issuance service, according to an embodiment of the present disclosure.

First of all, a user may utilize an open badge issuance service through a separate platform or webpage established and provided by the service server 300.

Referring to FIG. 9, a dashboard for the corresponding user may be displayed on a display module 110 of the user terminal 100 in a portfolio format.

That is, a user may identify his/her own DID status by launching a web page or platform through his/her terminal (i.e., the user terminal 100). In this case, the DID status may be implemented in a portfolio format on a separately configured dashboard and may be displayed on the display module 110.

In particular, enrollment information about at least one lecture that the user is taking may be displayed in a first region 111. In the case, a completion status for each lecture may also be displayed. Besides, open badges issued for each lecture that the user has completed may be placed and classified for each category in a second region 112. Furthermore, although not shown in FIG. 9, additional open badges provided as rewards may also be placed and managed within the same category or a separate category.

However, a screen configuration of FIG. 9 is only an example and is not limited to information to be placed or the format thereof.

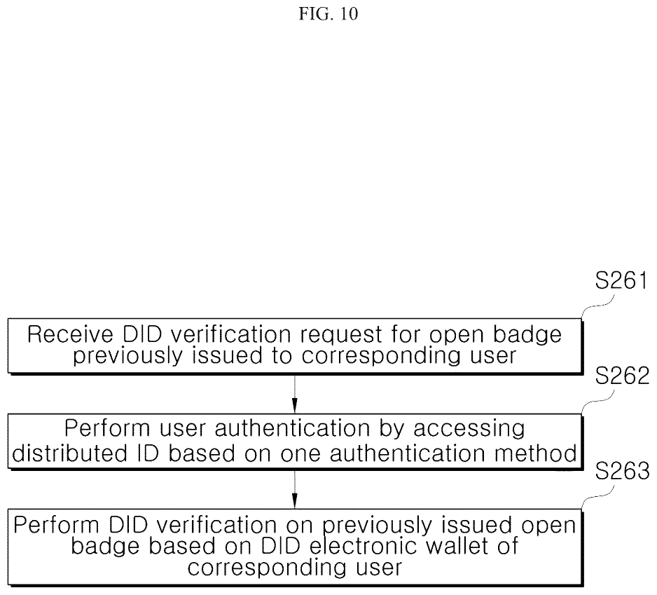

FIG. 10 is a flowchart showing a specific operation of performing DID verification in a method for providing a gamification-based open badge issuance service, according to an embodiment of the present disclosure.

Referring to FIG. 10, when a DID verification request for an open badge previously issued to the corresponding user is received from the user terminal 100 or the second institutional terminal 400 (S261), the service server 300 performs user authentication by accessing a distributed ID based on one of a plurality of authentication methods (S262).

Next, the service server 300 performs DID verification on the previously issued open badge, for which verification is requested in step S261, based on a DID electronic wallet of the corresponding user, which is registered in a blockchain (S263).

In this case, step S263 may be used to verify badge issuance data by using a hash value of an open badge (an open badge for which DID verification is requested) thus previously issued, and a hash value of the open badge previously registered in the blockchain. Here, the hash value of the previously issued open badge may be obtained based on a public key used to sign the digitally signed assertion on the open badge.

The above-described program may include a code encoded by using a computer language such as C, C++, JAVA, a machine language, or the like, which a processor (CPU) of the computer may read through the device interface of the computer, such that the computer reads the program and performs the methods implemented with the program. The code may include a functional code related to a function that defines necessary functions executing the method, and the functions may include an execution procedure related control code necessary for the processor of the computer to execute the functions in its procedures. Furthermore, the code may further include a memory reference related code on which location (address) of an internal or external memory of the computer should be referenced by the media or additional information necessary for the processor of the computer to execute the functions. Further, when the processor of the computer is required to perform communication with another computer or a server in a remote site to allow the processor of the computer to execute the functions, the code may further include a communication related code on how the processor of the computer executes communication with another computer or the server or which information or medium should be transmitted/received during communication by using a communication module of the computer.

The stored medium refers not to a medium, such as a register, a cache, or a memory, which stores data for a short time but to a medium that stores data semi-permanently and is read by a device. In detail, for example, the stored medium may include a read only memory (ROM), a random access memory (RAM), a CD-ROM, a magnetic tape, a floppy disk, and an optical data storage device, but the present disclosure is not limited thereto. That is, the program may be stored in various recording media on various servers that the computer may access, or various recording media on the computer of the user. In addition, the media may be distributed to a computer system connected to a network, and a computer-readable code may be stored in a distributed manner.

Steps or operations of the method or algorithm described with regard to an embodiment of the present disclosure may be implemented directly in hardware, may be implemented with a software module executable by hardware, or may be implemented by a combination thereof. The software module may reside in a random access memory (RAM), a read only memory (ROM), an erasable programmable ROM (EPROM), an electrically erasable programmable ROM (EEPROM), a flash memory, a hard disk, a removable disk, a CD-ROM, or a computer-readable recording medium well known in the art to which the present disclosure pertains.

Although an embodiment of the present disclosure are described with reference to the accompanying drawings, it will be understood by those skilled in the art to which the present disclosure pertains that the present disclosure may be carried out in other detailed forms without changing the scope and spirit or the essential features of the present disclosure. Therefore, the embodiments described above are provided by way of example in all aspects, and should be construed not to be restrictive.

According to the above-mentioned problem solving means of the present disclosure, it is possible to reduce a user's trouble of generally visiting an educational institution or the educational institution's homepage to obtain a certificate, an educational qualification, or the like and submitting it directly to consumers (submitting institutions), by issuing and providing a blockchain-based open badge linked to the user's academic achievement such that the user (learner) is capable of proving his/her qualifications acquired through education, learning, examination, or the like provided by the educational institution (learning institution), thereby reducing the time required for issuance and submission as well as incidental costs while security is guaranteed.

In the meantime, according to an embodiment of the present disclosure, it is possible to allow a user to easily check the user's fragmented history data by integrating and managing at least one open badge issued to the user, and to allow the user to post the fragmented history data to at least one SNS, thereby quickly and easily utilize the history data for employment or advancement.

In the meantime, according to an embodiment of the present disclosure, it is possible to issue various types of open badges in consideration of gamification for unit-specific capabilities and to provide points, gifts, etc. in addition to the open badges, thereby allowing users to voluntarily expand their capabilities by stimulating interest or motivation.

Effects of the present disclosure are not limited to the effects mentioned above, and other effects not mentioned will be apparent by those skilled in the art from the following description.

While the present disclosure has been described with reference to embodiments, it will be apparent to those skilled in the art that various changes and modifications may be made without departing from the spirit and scope of the present disclosure. Therefore, it should be understood that the above embodiments are not limiting, but illustrative.

What is claimed is:

1. A gamification-based open badge issuance service providing system, the system comprising:
a first institutional terminal configured to provide a learning service to a user terminal, and to create or update history information about a user by receiving learning performance result information from the user terminal;
the user terminal configured to perform learning through the learning service provided by the first institutional terminal, and to store an open badge issued upon requesting a service server to issue the open badge for the learning; and
a service server configured to:
when an open badge issuance request is received from the user terminal, determine whether to issue the open badge, by determining whether the user has an issuance qualification for the open badge requested to be issued;
when open badge issuance is completed, record the issued open badge on a decentralized identifiers (DID) electronic wallet of the user registered on a blockchain; and
determine whether to provide a reward, based on open badge issuance information and learning activity information of the corresponding user, and then generate issuance information according to the determination result.

2. The system of claim 1, wherein the service server is connected to at least one learning server and at least one search server to collect the learning activity information and search result information from the at least one learning server and the at least one search server.

3. The system of claim 2, wherein the service server is configured to:
analyze the open badge issuance information and the learning activity information of the corresponding user and determine whether at least one preset reward provision condition is satisfied, based on the analysis result;
when the determination result indicates that the at least one reward provision condition is not satisfied, generate the issuance information so as to include a first notification for providing learning motivation; and
when the determination result indicates that the at least one reward provision condition is satisfied, generate the issuance information so as to include a second notification for providing reward provision.

4. The system of claim 3, wherein the service server is configured to:
identify a degree to which the at least one reward provision condition is satisfied; and
determine a reward to be provided to the corresponding user based on the identified result, and then further include the reward in the second notification.

5. The system of claim 4, wherein the reward includes at least one of an additional open badge, a point, a coupon, a gift, and content.

6. The system of claim 5, wherein the additional open badge is a badge for a competency having a unit smaller than the open badge and is composed by structuring at least one grade, and
wherein the at least one grade includes at least one of a mega badge, a macro badge, a micro badge, and a nano badge.

7. The system of claim 6, wherein the service server is configured to:
determine a grade among the at least one grade based on an achievement degree of the at least one reward provision condition; and
issue a badge of the determined grade as a reward.

8. The system of claim 3, wherein the preset reward provision condition is automatically set or changed by analyzing the learning activity information of the user based on pre-stored curriculum information or is manually set or changed by the user.

9. The system of claim 1, wherein the service server is linked to the first institutional terminal based on an application programming interface (API) and performs at least one of DID user registration, open badge issuance, and DID verification for the corresponding user.

10. A gamification-based open badge issuance service providing method performed by a device, the method comprising:
when a corresponding user completely performs learning based on a learning service provided by a first institutional terminal, transmitting, by a user terminal, learning performance result information about the learning to the first institutional terminal;
generating or updating, by the first institutional terminal, history information about the corresponding user based on the learning performance result information;
when an open badge issuance request for the learning is received from the user terminal, determining, by a service server, whether the corresponding user has an issuance qualification for the open badge requested to be issued, through the first institutional terminal;
when the determination result indicates that the corresponding user has the issuance qualification for the open badge requested to be issued, issuing, by the service server, an open badge for the learning based on badge issuance data for the corresponding user;
recording, by the service server, the issued open badge in a DID electronic wallet of the corresponding user registered on a blockchain;
determining, by the service server, whether to provide a reward based on open badge issuance information and learning activity information of the corresponding user; and
generating, by the service server, issuance information based on the determination result.
